(19) United States
(12) Patent Application Publication
(10) Pub. No.: US 2022/0343225 A1
(43) Pub. Date: Oct. 27, 2022

(54) METHOD AND SYSTEM FOR CREATING EVENTS

(71) Applicant: Tata Consultancy Services Limited, Mumbai (IN)

(72) Inventors: Atul Suresh Patole, Mumbai (IN); Anish Aich, Kolkata (IN); Satadru Kundu, Kolkata (IN); Devaraj Ramanathan, Mumbai (IN); Samba Ghoshal, Kolkata (IN)

(73) Assignee: Tata Consultancy Services Limited, Mumbai (IN)

(21) Appl. No.: 17/695,931

(22) Filed: Mar. 16, 2022

(30) Foreign Application Priority Data
Mar. 16, 2021 (IN) 202121011144

(51) Int. Cl. G06Q 10/02; G06K 9/62; G06F 40/279; G06N 20/00

(52) U.S. Cl. CPC G06Q 10/02; G06K 9/623; G06K 9/6215; G06F 40/279; G06N 20/00

(57) ABSTRACT

While creating an event, even using a system, the user needs to put a lot of manual effort in collecting the required data and later for finding suitable suppliers who can organize the event. The disclosure herein generally relates to event creation, and, more particularly, to a method and system for creating events using historical event information. The system collects an event title (of the event being planned), as input. The system generates a vector representation of the received event title. The system then compares the vector representation of the event title with a plurality of historic event titles, using a data model, and based on the comparison, recommends a set of historic event titles, and corresponding details including event information, event duration, and supplier information. This data can be further used by the user to determine and finalize the event.

This U.S. patent application claims priority under 35 U.S.C. § 119 to: Indian Patent Application No. 202121011144, filed on March 16, 2021. The entire contents of the aforementioned application are incorporated herein by reference.

### TECHNICAL FIELD

The disclosure herein generally relates to event creation, and, more particularly, to a method and system for creating events using historical event information.

### BACKGROUND

As digitalization has become popular, now creating events (for example, a sourcing event) can be done easily using digital devices. However, this process is not fully automated, yet. A user who is handling a system for creating events still needs to put some manual efforts. For example, the user needs to make sure that data such as but not limited to information about the type of event to be created, questionnaire data required from suppliers, set of items to be sourced, and appropriate industry/organization approved suppliers from market to be invited for the sourcing event, and so on are available, which are inputs required for event creation. Further, even after creating an event, the user/organizer may have to put additional efforts for finding suitable suppliers who can organize the event.

### SUMMARY

Embodiments of the present disclosure present technological improvements as solutions to one or more of the above-mentioned technical problems recognized by the inventors in conventional systems. For example, in one embodiment, a processor implemented method for event recommendation is provided. In this method, an event title is received as input, via one or more hardware processors. Further, a vector representation of the received event title is generated, via the one or more hardware processors. Further, the vector representation of the event title is compared with a plurality of historic event titles, using a data model, via the one or more hardware processors. While comparing the vector representation of the event title with that of the historic event titles, initially a coefficient value for each of the plurality of historic event titles in comparison with the event title received as input is generated, using a coefficient-based voting algorithm, by calculating a plurality of distance values, between the generated vector representation of the received event title and a vector representation of the historic event title, using a plurality of distance calculation techniques, and then by multiplying each of the plurality of distance values with a unique weightage score of corresponding distance calculation technique. After generating the coefficient value, the plurality of historic event titles are ranked based on the generated coefficient value of each of the plurality of historic event titles. Further, a pre-defined number of historic event titles having highest value of the coefficient value from among the plurality of historic event titles are recommended via the one or more hardware processors.

In another aspect, a system for event recommendation is provided. The system includes one or more hardware processors, a communication interface, and a memory storing a plurality of instructions. The plurality of instructions when executed cause the one or more hardware processors to receive an event title is received as input. Further, a vector representation of the received event title is generated, via the one or more hardware processors. Further, the vector representation of the event title is compared with a plurality of historic event titles, using a data model, via the one or more hardware processors. While comparing the vector representation of the event title with that of the historic event titles, initially a coefficient value for each of the plurality of historic event titles in comparison with the event title received as input is generated, using a coefficient-based voting algorithm, by calculating a plurality of distance values, between the generated vector representation of the received event title and a vector representation of the historic event title, using a plurality of distance calculation techniques, and then by multiplying each of the plurality of distance values with a unique weightage score of corresponding distance calculation technique. After generating the coefficient value, the plurality of historic event titles are ranked based on the generated coefficient value of each of the plurality of historic event titles. Further, a pre-defined number of historic event titles having highest value of the coefficient value from among the plurality of historic event titles are recommended via the one or more hardware processors.

In yet another aspect, a non-transitory computer readable medium for event recommendation is provided. The non-transitory computer readable medium includes a set of instructions, which when executed, cause one or more hardware processors to perform the following steps for the event recommendation. Initially, an event title is received as input, via one or more hardware processors. Further, a vector representation of the received event title is generated, via the one or more hardware processors. Further, the vector representation of the event title is compared with a plurality of historic event titles, using a data model, via the one or more hardware processors. While comparing the vector representation of the event title with that of the historic event titles, initially a coefficient value for each of the plurality of historic event titles in comparison with the event title received as input is generated, using a coefficient-based voting algorithm, by calculating a plurality of distance values, between the generated vector representation of the received event title and a vector representation of the historic event title, using a plurality of distance calculation techniques, and then by multiplying each of the plurality of distance values with a unique weightage score of corresponding distance calculation technique. After generating the coefficient value, the plurality of historic event titles are ranked based on the generated coefficient value of each of the plurality of historic event titles. Further, a pre-defined number of historic event titles having highest value of the coefficient value from among the plurality of historic event titles are recommended via the one or more hardware processors.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 illustrates an exemplary block diagram of a system for generating event recommendations, according to some embodiments of the present disclosure.

FIG. 2 is a flow diagram depicting steps involved in the process of generating event recommendations using the system of FIG. 1, according to some embodiments of the present disclosure.

FIG. 3 is a flow diagram depicting steps involved in the process of selecting a set of historic event titles from a plurality of historic event titles, to generate the event recommendation using the system of FIG. 1, in accordance with some embodiments of the present disclosure.

FIG. 4 is a flow diagram depicting steps involved in the process of training a machine learning mod& for selecting a set of historic event titles from a plurality of historic event titles, to generate the event recommendation using the system of FIG. 1, in accordance with some embodiments of the present disclosure,

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

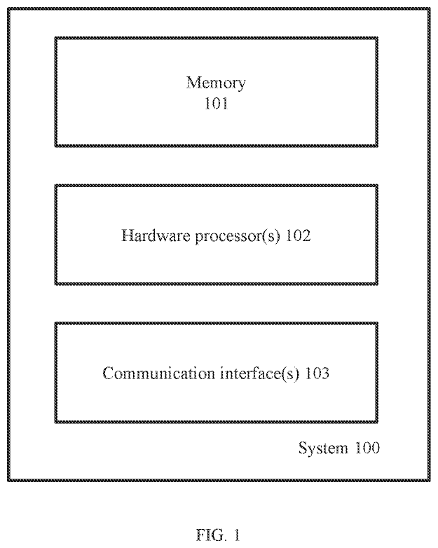

Referring now to the drawings, and more particularly to FIG. 1 through FIG. 4, where similar reference characters denote corresponding features consistently throughout the figures, there are shown preferred embodiments and these embodiments are described in the context of the following exemplary system and/or method.

FIG. 1 illustrates an exemplary block diagram of a system for event predictions, according to some embodiments of the present disclosure. The system 100 includes one or more hardware processors 102, communication interface(s) or input/output (I/O) interface(s) 103, and one or more data storage devices or memory 101 operatively coupled to the one or more hardware processors 102. The one or more hardware processors 102 can be implemented as one or more microprocessors, microcomputers, microcontrollers, digital signal processors, central processing units, state machines, graphics controllers, logic circuitries, and/or any devices that manipulate signals based on operational instructions. Among other capabilities, the processor(s) are configured to fetch and execute computer-readable instructions stored in the memory. In an embodiment, the system 100 can be implemented in a variety of computing systems, such as laptop computers, notebooks, hand-held devices, workstations, mainframe computers, servers, a network cloud and the like.

The communication interface(s) 103 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the communication interface(s) 103 can include one or more ports for connecting a number of devices to one another or to another server.

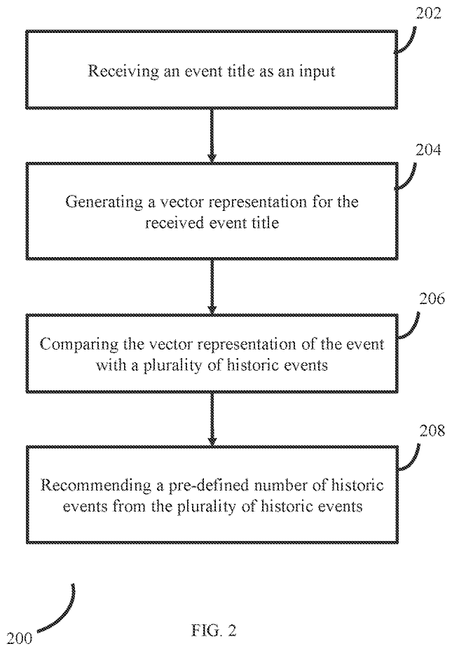

The memory 101 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, one or more components (not shown) of the system 100 can be stored in the memory 101. The memory 101 is configured to store a plurality of operational instructions (or ‘instructions’) which when executed cause one or more of the hardware processor(s) 102 to perform various actions associated with the event recommendation being performed by the system 100. The system 100 can be implemented in a variety of ways as per requirements. Various steps involved in the process of event recommendation being performed by the system 100 are explained with description of FIGS. 2, 3, and 4. All the steps in FIGS. 2, 3A, 3B, 3C, and 4 are explained with reference to the system of FIG. 1.

FIG. 2 is a flow diagram depicting steps involved in the process of generating event recommendations using the system of FIG. 1, according to some embodiments of the present disclosure. In order to create an event, a user of the system 100 can initially decide a suitable event title that matches/indicates one or more characteristics of the event being planned. The user then inputs the decided title to the system 100 using a suitable user interface.

At step 202, the system 100 receives/collects the event title entered by the user as input. The system 100 may then do some standard pre-processing to interpret the collected input. Further, at step 204, the system 100 generates a vector representation of the event title.

For any given event title, the system 100 generates the vector representation by executing the following steps:
Remove stop words from the event titles to generate corresponding ‘clean titles’
Identify unique words from the clean titles
Calculated the IDF (Inverse Document Frequency) of all the unique words
Calculated the TF (Term Frequency) of each unique word
Calculated TF*IDF to form the word vectors

This process is now explained by taking an example:

For example, consider that a training document set contains two documents d1 and d2, and a test document set contains two other documents d3 and d4.

### Train Document Set:

d1: Event IT Hardware
d2: Event Laptop premium standard

### Test Document Set:

d3: Event Electrical equipment
d4: Event Laptop premium moderate standard

Vectorization is done for the test dataset based on the documents in the training data set. Initially the system 100 removes all the stop words from the titles from each of documents, to generate the clean titles. The system 100 then identifies and extracts unique words from the titles. For the test and training data sets, the unique words extracted by the system are:

### [Event IT ,Hardware, Laptop, Premium, Standard]

The system 100 then calculates an Inverse Document Frequency (IDF) for each of the unique words, as:

IDF=log (1+n/1+df(d,t))+1 (1)

### Where,

df(d,t) represents frequency of the term, and
‘n’ is number of documents in which the term is present

With some example values given, consider that the IDF values calculated for each of the unique words is as given below:
Event-1
IT-2.09
Hardware-2.09
Laptop-1.40
Premium-1.40
Standard-1.40

Based on the calculated IDF values, an IDF vector is generated by the system 100, and is represented as=(1 2.09 2.09 1.40 1.40 1.40).

The IDF values may be represented in a matrix form as:

[[1,0,0,0,0,0], [0,2.09,0,0,0,0], [0,0,0,2.09,0,0], [0,0,0,1.40,0,0], [0,0,0,0,1.40,0], [0,0,0 0,0,1.40]]

Where, in the matrix form, the values are in the order:
[Event, IT, Hardware, Laptop, premium, standard]

The system 100 then calculates a Term Frequency (TF) vector as:

Tf vector=[[1,0,0,0,0,0] [1,0,0,1,0,1]]

Where, TF is number of times a word appears in a document divided by the total number of words in the document.

The system 100 then calculates value of Tf-Idf as:

Tf-Idfij=IFi,j*log(1+n/(1+dfi))+1 (2

Using equation (2), the value of Tf-Idf is calculated for the above referenced values as:

Tf-Idf=[[1,0,0,0,0,0],[1,0,0,1,0,1]]* [[1,0,0,0,0,0], [0,2.09,0,0,0,0], [0,0,0,2.09,0,0], [0,0,0,1.40,0,0], [0,0,0,0,1.40,0], [0,0,0,0,0,1.40]]=[[100000][1001.401.4]]

The system 100 then performs 12 normalization on the calculated Tf-Idf value to generate the vector representation as equal to:

[[100000][0.33000.6600.66]]

The system 100 stores in a data repository in the memory 101, details of a plurality of historical event titles, each representing a historical/past event, along with details of each of the events. The ‘details’ of the event may include information such as but not limited to time stamp of the event, number of participants, supplier/organizer of each event, cost of the event, and so on. The historic event titles and details may be automatically fetched from any external sources or may be manually entered to the system 100 using a suitable interface provided.

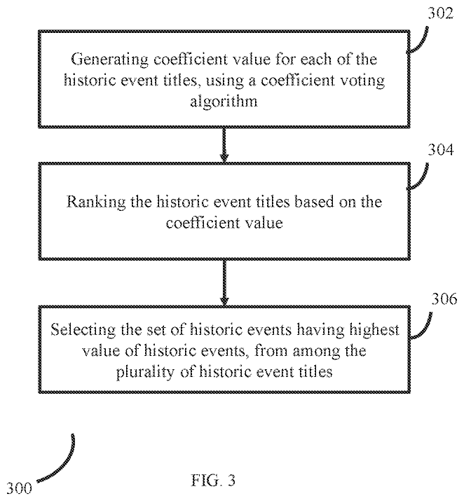

At step 206, the system 100 compares the vector representation of the event title with vector representation of each of the historic event titles. In an embodiment, the vector representations of the plurality of historic event titles are generated dynamically each time an input data is collected and processed by the system 100. In another embodiment, the vector representations of all the historical event titles are generated once and are stored in the database. When the vector representations of the historic event titles are to be compared with the vector representation of the input data, the system 100 fetches the vector representations from the database. Steps involved in the process of comparing the vector representations of the input event title and the vector representations of the historic event titles are depicted in FIG. 3.

At step 302, the system 100 generates a coefficient value for each of the historic event titles, using a coefficient voting algorithm. At this step, the system 100 may use a plurality of suitable techniques (Natural Language Processing (NLP), and Word Processing (WP) techniques) to calculate distance between the vector representation of the input event title and each of the historic event titles. A few examples of techniques that may be used for calculating the distance are Word Mover's distance, Classic Cosine similarity, Global Vectors for Word representation (GloVe),and Siamese Manhattan LSTM (SMLS™). In an embodiment, a selected number of such techniques are pre-configured with the system 100 for automatic execution. In another embodiment, the system 100 may prompt the user to make a selection of one or more of the techniques, using a suitable user interface. Each of the techniques is assigned a unique weightage score. The system 100 multiplies the distance values calculated by each technique with the corresponding weightage of each of the techniques to generate the coefficient value. In an embodiment, the weightage score of each of the techniques (in turn the combination of weightage scores of all the techniques used) is determined during training of a machine learning data model being used by the system 100 for processing the input data received.

Further, at step 304, the system 100 ranks each of the plurality of historic event titles, based on the coefficient value. After anking the plurality of historic event titles, the system 100, at step 306, selects a pre-defined number of historic event titles having highest coefficient value among the plurality of historic event titles. The system 100 may then recommend the selected pre-defined number of historic event titles to the user, at step 208. The system 100 also provides option for the user to access details of each of the historic/past events represented by each of the recommended historic event titles.

Along with the historic event title suggestion, the system 100 also recommends one or more suppliers who can handle the event being planned by the user, and an estimated event duration, which the user may consider while planning the event.

In order to recommend the one or more suppliers, the system 100 identifies a plurality of suppliers of the recommended pre-defined number of historic event titles. Further, for each of the plurality of suppliers, the system 100 generates a weighted average score based on a determined similarity of corresponding historic event titles (which may be represented by the assigned ranking of each of the historical evet titles) with the input event title, and values of a plurality of configurable attributes. Further, based on the suppliers having the highest value of the weighted average score, the system 100 generates recommendation of the one or more suppliers.

In order to estimate the event duration, the system 100 identifying a supplier who has been shortlisted by the user. The shortlisted supplier may or may not be from the recommendations generated by the system 100. Once the supplier is identified, the system 100 identifies a plurality of events organized by the shortlisted supplier, The system 100 then applies a multiple linear regression model on the identified plurality of events to determine a tentative event duration.

The user may use the recommendations (historic event titles, suppliers, and the estimated event duration) to generate the event/further plan the event. The system 100 may provide an option for the user to make modifications to any of the historic events, as per requirements of the task being planned.

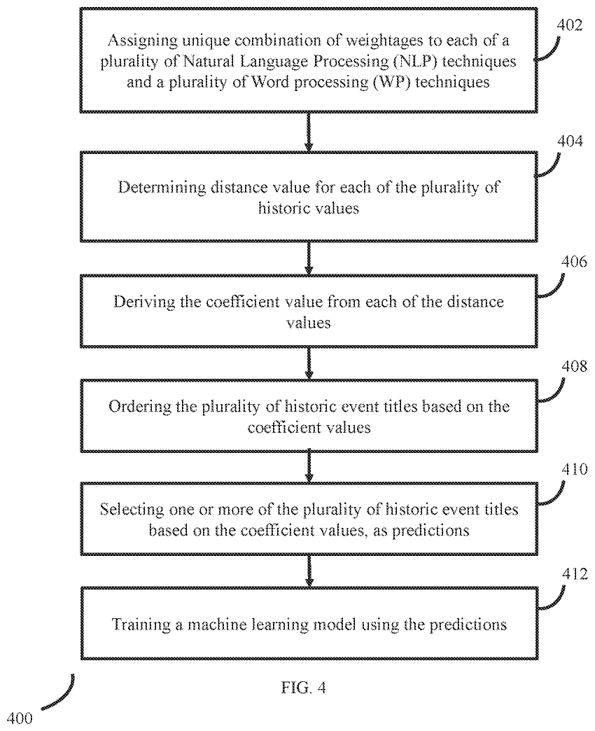

FIG. 4 is a flow diagram depicting steps involved in the process of training a machine learning model for selecting a set of historic event titles from a plurality of historic event titles, to generate the event recommendation using the system of FIG. 1, in accordance with some embodiments of the present disclosure. The system 100 uses the machine learning model to process the input event title, using the steps in FIG. 2 and FIG. 3 to generate the recommendations. The machine learning model is initially trained using data pertaining to the historic/past events, using the steps in method 400. Steps in method 400 are almost identical to the steps in method 200 and 300. However while generating/training the machine learning data model, the system 100 uses a plurality of combinations of weightage values for the techniques being considered, and determines/identifies a combination of weightages for which accuracy of the machine learning data model is closest to a pre-defined accuracy benchmark. The predictions generated by the system 100 for each input provided, are one of the inputs for training and updating the machine learning data model. In an embodiment, in addition to the predictions generated, the system 100 may collect information on data such as but not limited to historic event title(s), supplier(s), and event duration selected/opted by the user, and use the collected data for training the machine learning data model.

### Use-Case Scenario/Example

Consider that a user is trying to create an event for Request for Proposal (RFP)/auction, Training data (i.e. historical sourcing data, in this context), used by the system 100 for training the machine learning model is given in Table. 1.

TABLE 1

| | | | Event | Event | | |
|---|---|---|---|---|---|---|
| Event ID | Event Title | Event Type | Category | Status | Quantity | Price |
| andE8331 | Bulk laptop | RFQ | IT | Closed | 50 | 29000 |
| | order with | | Hardware | | | |
| | standard | | | | | |
| | configuration | | | | | |
| E8923 | Order for | RFQ | IT | Closed | 10 | 12000 |
| | computer | | Hardware | | | |
| | accessories | | | | | |
| E8932 | High | RFQ | IT | Published | 12 | 150000 |
| | configuration | | Hardware | | | |
| | laptop | | | | | |
| | sourcing | | | | | |
| | event | | | | | |
| E8120 | Event for IT | RFQ | IT | Closed | 20 | 50000 |
| | Hardware | | Hardware | | | |
| E3933 | Event for | RFP | IT | Closed | 10 | 120000 |
| | laptop of | | Hardware | | | |
| | premium | | | | | |
| | standard | | | | | |
| E1200 | Event for | Auction | Electrical | Published | 40 | 45000 |
| | electrical | | | | | |
| | equipment | | | | | |

Consider that the techniques used for processing the training data are Word Mover's Distance, Classic Cosine Similarity, GloVe, and MaLSTM. Each of these techniques is assigned an initial weightage of 0.25, and the machine learning mod& is generated/built. While generating the predictions, the system 100 is configured to use a combination of weightages assigned to the selected techniques. Example of weightage combinations are given in Table. 2.

TABLE 2

| | | Global Vectors | Siamese |
|---|---|---|---|
| | | for Word | Manhattan |
| Word Mover's | Classic Cosine | Representation | LSTM |
| Distance | Similarity | (GloVe) | (MaLSTM) |
| 0.25 | 0.25 | 0.25 | 0.25 |
| 0.30 | 0.20 | 0.25 | 0.25 |
| 0.35 | 0.15 | 0.25 | 0.25 |
| 0.40 | 0.10 | 0.25 | 0.25 |
| 0.45 | 0.05 | 0.25 | 0.25 |
| 0.50 | 0.00 | 0.25 | 0.25 |
| 0.30 | 0.25 | 0.20 | 0.25 |
| 0.35 | 0.25 | 0.15 | 0.25 |
| 0.40 | 0.25 | 0.10 | 0.25 |
| 0.45 | 0.25 | 0.05 | 0.25 |
| 0.50 | 0.25 | 0.25 | 0.25 |
| 0.30 | 0.25 | 0.25 | 0.20 |
| 0.35 | 0.25 | 0.25 | 0.15 |
| 0.40 | 0.25 | 0.25 | 0.10 |
| 0.45 | 0.25 | 0.25 | 0.05 |
| 0.50 | 0.25 | 0.25 | 0.00 |

Consider that the input event title to the system 100 is “Event for top-end laptop sourcing”. This event title is referred to as “test event title”.

From the training data, the top n (wherein in this example, value of ‘n’ is considered as 3) best matching event titles are conformed as accuracy benchmark to be:
Event for Laptop of premium standard
High Configuration Laptop Sourcing Event
Bulk Laptop Order with standard configuration

The test event title is pre-processed using the NLP techniques and corresponding vector representation is generated. The system 100 then uses the machine learning data model to find the top 3 best matching historical event titles using each of the techniques, Consider that the results returned by each of the techniques are as in Table. 3.

TABLE 3

| Word | Classic | | |
|---|---|---|---|
| Mover's | Cosine | | |
| Distance | Similarity | GloVe | MaLSTM |
| High | High | High | Event for |
| configuration | configuration | configuration | laptop |
| laptop sourcing | laptop sourcing | laptop sourcing | of premium |
| event | event | event | standard |
| Event for | Bulk Laptop | Event for | High |
| laptop | Order with | laptop | configuration |
| of premium | standard | of premium | laptop sourcing |
| standard | configuration | standard | event |
| Bulk Laptop | Event for | Event for | Bulk Laptop |
| Order with | laptop | laptop | Order with |
| standard | of premium | of premium | standard |
| configuration | standard | standard | configuration |

Further the system 100 uses a majority voting algorithm ‘X’ to mine out an ensemble prediction from the table. 2 as:
High Configuration Laptop Sourcing Event
Event for Laptop of premium standard
Bulk Laptop Order with standard configuration

The system 100 further generates the coefficient value for each of the historic event titles using the Voting Algorithm, The voting algorithm multiplies a distance value calculated by each technique with the corresponding weightages assigned to the technique in each iteration to derive the coefficient value. The system 100 further sorts the historic event titles based on the generated coefficient value of each of the historic event titles. Further, ‘n’ historic event titles having highest coefficient values are identified as the ‘predictions’ by the system 100.

This process is reiterated for all the weightage combinations present in table 2.0 and ensemble prediction results are stored and matched with an accuracy benchmark. The first combination of weightages for which the ensemble prediction results matches with the accuracy benchmark, iteration is stopped and the model is finalized for the test data.

This process is repeated for different training data, to generate/fine-tune/update the machine learning data mod& for finding the best matching event title. During this process, the system 100 may identify most occurring combination of weightages, which in turn may be used by the system for building a final version of the machine learning data model.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein addresses unresolved problem of event generation/creation. The embodiment, thus provides a mechanism to generate recommendations of historic event titles matching an input title provided by a user. Moreover, the embodiments herein further provide a method of recommending supplier(s) and an estimated event duration, which may be used by the user as inputs for generating/creating an event being planned,

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof, The device may also include means which could be e.g, hardware means like e.g, an application-specific integrated circuit (ASIC), a field-programmable gate array (FPGA), or a combination of hardware and software means, e.g. an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements, The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed, Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent n meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method for event recommendation, comprising:
receiving an event title as input, via one or more hardware processors;
generating a vector representation of the received event title, via the one or more hardware processors;
comparing the vector representation of the event title with a plurality of historic event titles, using a data model, via the one or more hardware processors, comprising:
generating a coefficient value for each of the plurality of historic event titles in comparison with the event title received as input, using a coefficient-based voting algorithm, wherein generating the coefficient value for each of the plurality of historic event titles comprises:
calculating a plurality of distance values, between the generated vector representation of the received event title and a vector representation of the historic event title, using a plurality of distance calculation techniques; and
multiplying each of the plurality of distance values with a unique weightage score of corresponding distance calculation technique; and
ranking the plurality of historic event titles based on the generated coefficient value of each of the plurality of historic event titles; and
recommending a pre-defined number of historic event titles having highest value of the coefficient value, from among the plurality of historic event titles, via the one or more hardware processors. The method as claimed in claim 1, wherein the data model is generated by:
iteratively assigning a plurality of unique combinations of weightages to a set of a plurality of word processing (WP) techniques and a plurality of natural language processing (NLP) techniques;
determining distance value for each of the plurality of historic event titles, using each of the plurality of WP and NLP techniques, for each unique combination of weightages assigned;
deriving the coefficient value from each of the distance values, based on the assigned unique combination of weightages;
ordering the plurality of historic event titles based on the coefficient value;
selecting one or more of the plurality of historic event titles, based on the coefficient value, as predictions;
determining accuracy of the predictions, generated for each unique combination of weightages;
selecting predictions for which the determined accuracy is at least equal to a defined accuracy benchmark; and
training a machine learning data model using the selected predictions for which the determined accuracy is at least equal to a defined accuracy benchmark.

3. The method as claimed in claim 1, wherein recommending the pre-defined number of historic event titles comprises recommending one or more suppliers and an event duration, for the event.

4. The method as claimed in claim 3, wherein recommending the one or more suppliers comprises:
identifying a plurality of suppliers of the recommended pre-defined number of historic event titles;
generating a weighted average score for each of the plurality of suppliers, based on the determined similarity of corresponding historic event titles and values of a plurality of configurable attributes related to the event title received as input; and
generating recommendation of one or more of the identified plurality of suppliers, based on the generated weighted average score.

5. The method as claimed in claim 3, wherein recommending the event duration comprises:
identifying shortlisted supplier;
identifying a plurality of events organized by the shortlisted supplier; and
applying a multiple linear regression model on the identified plurality of events to determine a tentative event duration.

6. A system for event recommendation, comprising:
one or more hardware processors;
a communication interface; and
a memory storing a plurality of instructions, the plurality of instructions when executed cause the one or more hardware processors to:
receive an event title as input;
generate a vector representation of the received event title;
compare the vector representation of the event title with a plurality of historic event titles, using a data model, comprising:
generating a coefficient value for each of the plurality of historic event titles in comparison with the event title received as input, using a coefficient-based voting algorithm, wherein generating the coefficient value for each of the plurality of historic event titles comprises:
calculating a plurality of distance values, between the generated vector representation of the received event title and a vector representation of the historic event title, using a plurality of distance calculation techniques; and
multiplying each of the plurality of distance values with a unique weightage score of corresponding distance calculation technique; and
ranking the plurality of historic event titles based on the generated coefficient value of each of the plurality of historic event titles; and
recommend a pre-defined number of historic event titles having highest value of the coefficient value, from among the plurality of historic event titles.

7. The system as claimed in claim 6, wherein the system generates the data model by:
iteratively assigning a plurality of unique combinations of weightages to a set of a plurality of word processing (WP) techniques and a plurality of natural language processing (NLP) techniques;
determining distance value for each of the plurality of historic event titles, using each of the plurality of WP and NLP techniques, for each unique combination of weightages assigned;
deriving the coefficient value from each of the distance values, based on the assigned unique combination of weightages;
ordering the plurality of historic event titles based on the coefficient value;
selecting one or more of the plurality of historic event titles, based on the coefficient value, as predictions;
determining accuracy of the predictions, generated for each unique combination of weightages;
selecting predictions for which the determined accuracy is at least equal to a defined accuracy benchmark; and
training a machine learning data model using the selected predictions for which the determined accuracy is at least equal to a defined accuracy benchmark.

8. The system as claimed in claim 6, wherein recommending the pre-defined number of historic event titles comprises recommending one or more suppliers and an event duration, for the event.

9. The system as claimed in claim 8, wherein the system recommends the one or more suppliers by:
identifying a plurality of suppliers of the recommended pre-defined number of historic event titles;
generating a weighted average score for each of the plurality of suppliers, based on the determined similarity of corresponding historic event titles and values of a plurality of configurable attributes; and
generating recommendation of one or more of the identified plurality of suppliers, based on the generated weighted average score

10. The system as claimed in claim 8, wherein the system recommends the event duration by:
identifying shortlisted supplier;
identifying a plurality of events organized by the shortlisted supplier; and
applying a multiple linear regression model on the identified plurality of events to determine a tentative event duration.

11. One or more non-transitory machine-readable information storage mediums comprising one or more instructions which when executed by one or more hardware processors cause:
receiving an event title as input, via one or more hardware processors;
generating a vector representation of the received event title, via the one or more hardware processors;
comparing the vector representation of the event title with a plurality of historic event titles, using a data model, via the one or more hardware processors, comprising:
generating a coefficient value for each of the plurality of historic event titles in comparison with the event title received as input, using a coefficient-based voting algorithm, wherein generating the coefficient value for each of the plurality of historic event titles comprises:
calculating a plurality of distance values, between the generated vector representation of the received event title and a vector representation of the historic event title, using a plurality of distance calculation techniques; and
multiplying each of the plurality of distance values with a unique weightage score of corresponding distance calculation technique; and
ranking the plurality of historic event titles based on the generated coefficient value of each of the plurality of historic event titles; and
recommending a pre-defined number of historic event titles having highest value of the coefficient value, from among the plurality of historic event titles, via the one or more hardware processors.

12. The one or more non-transitory machine-readable information storage mediums of claim 11, wherein the data model is generated by:
iteratively assigning a plurality of unique combinations of weightages to a set of a plurality of word processing (WP) techniques and a plurality of natural language processing (NLP) techniques;
determining distance value for each of the plurality of historic event titles, using each of the plurality of WP and NLP techniques, for each unique combination of weightages assigned;
deriving the coefficient value from each of the distance values, based on the assigned unique combination of weightages;
ordering the plurality of historic event titles based on the coefficient value;
selecting one or more of the plurality of historic event titles, based on the coefficient value, as predictions;
determining accuracy of the predictions, generated for each unique combination of weightages;
selecting predictions for which the determined accuracy is at least equal to a defined accuracy benchmark; and
training a machine learning data model using the selected predictions for which the determined accuracy is at least equal to a defined accuracy benchmark.

13. The one or more non-transitory machine-readable information storage mediums of claim 11, wherein recommending the pre-defined number of historic event titles comprises recommending one or more suppliers and an event duration, for the event.

14. The one or more non-transitory machine-readable information storage mediums of claim 13, wherein recommending the one or more suppliers comprises:
identifying a plurality of suppliers of the recommended pre-defined number of historic event titles;
generating a weighted average score for each of the plurality of suppliers, based on the determined similarity of corresponding historic event titles and values of a plurality of configurable attributes related to the event title received as input; and
generating recommendation of one or more of the identified plurality of suppliers, based on the generated weighted average score.

15. The one or more non-transitory machine-readable information storage mediums of claim 13, wherein recommending the event duration comprises:
identifying shortlisted supplier;
identifying a plurality of events organized by the shortlisted supplier; and
applying a multiple linear model on the identified plurality of events to determine a tentative event duration.
